(19) United States
(12) Patent Application Publication
(10) Pub. No.: US 2021/0071825 A1
(43) Pub. Date: Mar. 11, 2021

(54) CROSS-COUNTRY RUNNING LAMP

(71) Applicant: SYSMAX INNOVATIONS CO., LTD., Guangzhou (CN)

(72) Inventor: WENJIE LI, GUANGZHOU (CN)

(21) Appl. No.: 16/774,125

(22) Filed: Jan. 28, 2020

(30) Foreign Application Priority Data
Sep. 9, 2019 (CN) 201921498034.2

(51) Int. Cl. F21L 4/04; F21V 23/04; F21V 21/14; F21V 21/088

(52) U.S. Cl. CPC F21L 4/045; F21V 23/04; F21Y 2115/10; F21V 21/0885; F21V 21/145

(57) ABSTRACT

Provided is a cross-country running lamp which includes a lamp body, at least two lamp heads and at least one switch. The lamp heads are disposed on a peripheral side of the lamp body for illumination. The switch is disposed on the lamp body for controlling on-off and brightness of the lamp heads.

### CROSS-REFERENCE TO RELATED APPLICATIONS

This application claims priority to Chinese Application No. 201921498034.2 having a filing date of Sep. 9, 2019, the entire contents of which are hereby incorporated by reference.

### FIELD OF TECHNOLOGY

The following relates to the technical field of illumination, and more particularly, to a cross-country running lamp.

### BACKGROUND

When running outdoors, climbing or hiking, runners will use portable lighting devices to illuminate their surroundings in low-light environment and to clear obstacles on the path.

Conventional art portable lighting devices such as portable flashlight and headlamp are generally equipped with only one light source, and the illumination effect is relatively simple.

### SUMMARY

A cross-country running lamp is disclosed which can includes a lamp body, at least two lamp heads and at least one switch. The lamp heads is disposed on a peripheral side of the lamp body for illumination. The switch is disposed on the lamp body for controlling on-off and brightness of the lamp heads.

In some embodiments, the lamp heads may include a front lamp head and a rear lamp head. The cross-country running lamp may include a front switch and a rear switch. The front lamp head, the front switch, the rear lamp head and the rear switch can be disposed successively around a center line of the lamp body.

In some embodiments, the lamp heads may include a first lamp head, a second lamp head, a third lamp head and a fourth lamp head. The first lamp head, the second lamp head, the third lamp head and the fourth lamp head are disposed successively around a center line of the lamp body.

Optional, or in conjunction with the foregoing, the cross-country running lamp may further includes an astigmatic lens. The astigmatic lens is disposed on an illuminating side of the lamp body.

### BRIEF DESCRIPTION OF THE DRAWINGS

Some of the embodiments will be described in detail, with reference to the following figures, wherein like designations denote like members, wherein:

FIG. 1 is an assembly diagram of a cross-country running lamp according to Embodiment 1;

FIG. 2 is an exploded schematic diagram of the cross-country running lamp according to Embodiment 1;

FIG. 3 is an internal schematic diagram of a shell according to Embodiment 1;

FIG. 4 is an internal schematic diagram of the shell according to Embodiment 2;

FIG. 5 is an assembly diagram of a cross-country running lamp according to Embodiment 2; and

FIG. 6 is an exploded diagram of a cross-country running lamp according to Embodiment 3.

Following is a glossary of elements identified in the Figures:

100—Mounting bracket; 110—Mounting hole; 120—Holder; 121—Through hole; 200—Lamp body; 210—Groove; 220—End cover; 230—Shell; 231—Cavity; 300—Front lamp head; 310—LED light source; 320—Reflective cup; 330—Lens; 340—Pressure ring; 400—Rear lamp head; 500—Switch; 510—Front switch; 520—Rear switch; 600—Astigmatic lens; 610—Rotating bracket; 700—First lamp head; 800—Second lamp head; 900—Third lamp head; 1000—Fourth lamp head; 1100—Holding clip.

### DETAILED DESCRIPTION

### Embodiment 1

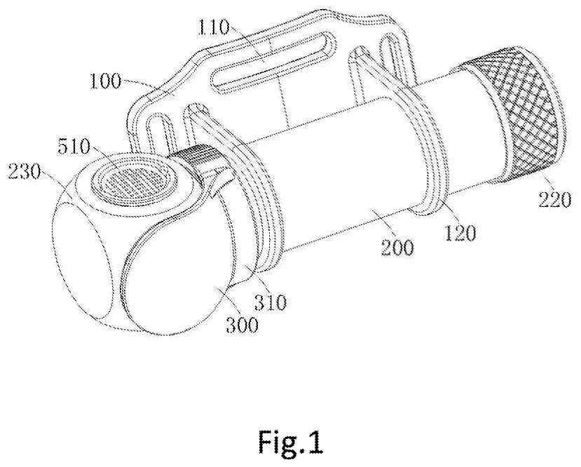

As shown in FIGS. 1-3, a cross-country running lamp includes a mounting bracket 100, a lamp body 200 and an astigmatic lens 600. Wherein, the lamp body 200 is detachably mounted on a headlamp belt (not shown in the figures, the headlamp belt may be an existing one used to attach a headlight to head) through the mounting bracket 100. There are at least two lamp heads for illumination disposed on the peripheral side of the lamp body 200. Specifically, two lamp heads are disposed on the peripheral side of the lamp body 200, which are a front lamp head 300 and a rear lamp head 400. There is at least one switch disposed on the lamp body 200, for controlling on-off or brightness of the lamp heads. In this embodiment, two switches are disposed on the lamp body 200, which are a front switch 510 and a rear switch 520, respectively. The front switch 510 controls the on, off and brightness of the front lamp head 300, and the rear switch 520 controls the on, off and brightness of the rear lamp head 400. The astigmatic lens 600 is disposed on the lamp body 200, and the astigmatic lens 600 is located on the illuminating side of the lamp body 200, and configured to allow light emitted from one of the lamp heads pass through.

The mounting bracket 100 is made of elastic material, and in this embodiment, the mounting bracket 100 is made of silica gel. At least one mounting hole 110 is formed on the mounting bracket 100, and the mounting hole 110 is used to allow the headlamp belt to pass through to connect the headlamp belt to the mounting bracket 100. At least one holder 120 is disposed on the surface of the mounting bracket 100 away from head. The holder 120 has at least one through hole 121 for inserting the lamp body 200, which is matched with the lamp body 200 to achieve the fixed installation of the lamp body 200 on the mounting bracket 100.

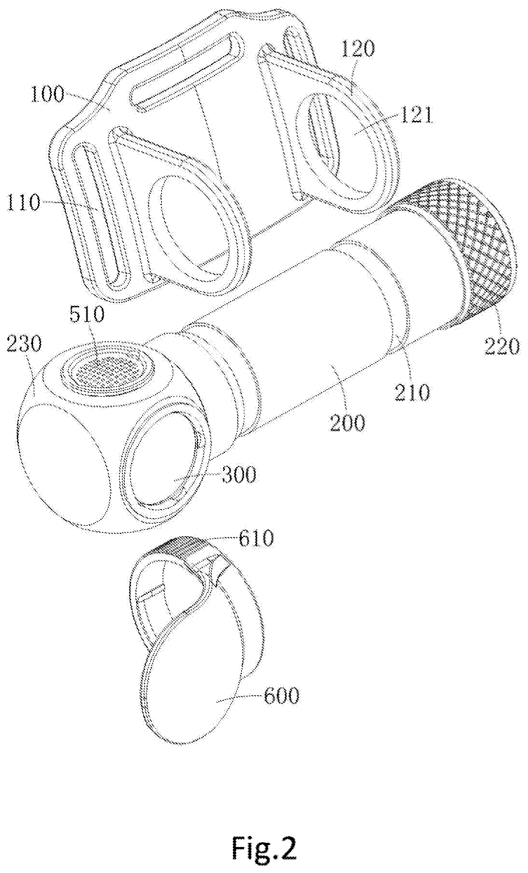

As shown in FIGS. 1 and 2, the lamp body 200 is a round rod, which is made of aerospace grade aluminum alloy. The external surface of the lamp body 200 is treated with three—stage wear—resistant surface hardening process. Specifically, at least one annular groove 210 is formed on the external surface of the lamp body 200, the groove 210 is matched with the through hole 121 to define the position of holder 120 relative to the lamp body 200. The lamp body 200 has a battery compartment (not shown in the figures), which is used for battery installation. One end of the lamp body 200 is threaded with an end cover 220, and the battery compartment can be opened to take or place a battery by unscrewing the end cover 220; the other end of the lamp body 200 is provided with a spherical shell 230. When the lamp body 200 is mounted on the holder 120, the end cover 220 is located on one side of the mounting bracket 100, and the shell 230 is located on the other side of the mounting bracket 100.

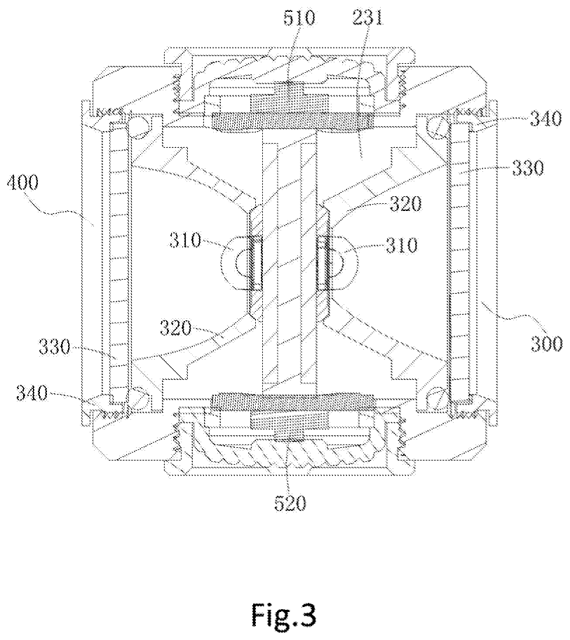

As shown in FIGS. 1-3, around the axis of the lamp body 200, there are four cavities 231 on the external surface of the shell 230, and the four cavities 231 are equidistant circular arrays on the peripheral side of the shell 230, and the opening surfaces of the adjacent cavities 231 are perpendicular to each other. Among the four cavities 231, a pair of cavities 231 opposite to each other are equipped with the front lamp head 300 and the rear lamp head 400 respectively, and another pair of cavities 231 opposite to each other are equipped with the front switch 510 and the rear switch 520 respectively. Thus, as shown in FIG. 3, the external surface of the front lamp head 300 is perpendicular to the external surface of the front switch 510, the external surface of the front lamp head 300 is perpendicular to the external surface of the rear switch 520, and the external surface of the front lamp head 300 is parallel to the external surface of the rear lamp head 400. The illumination effect of the front lamp head 300 is different from that of the rear lamp head 400, and the front lamp head 300 and the rear lamp head 400 may be illuminated at different times. In actual operation, working modes of the lamp heads are selected by the times of pressing the switch. For example, when pressing the front switch 510 for the first time, the front lamp head 300 is turned on and emits strong light; when pressing the front switch 510 for the second time, the front lamp head 300 emits weak light; when pressing the front switch 510 for the third time, the front lamp head 300 is turned off.

As shown in FIG. 3, specifically, the front lamp head 300 includes an LED light source 310, a reflective cup 320, a lens 330 and a pressure ring 340. Along the opening direction of the cavity 231 where the front lamp head is located, the LED light source 310, the reflective cup 320, the lens 330 and the pressure ring 340 are disposed on the shell 230 successively. The structure of the rear lamp head 400 is basically the same as that of the front lamp head 300, only the installation position of the rear lamp head 400 is different from that of the front lamp head 300. The structure of the rear lamp head 400 will not be further discussed herein. In this embodiment, the LED light source 310 is an LED lamp bead in the conventional art, the reflective cup 320 is a reflector in the conventional art, and the lens 330 is the transparent lens in the conventional art.

Manufacturing materials of the LED light source of the front lamp head 300 and the rear lamp head 400 are different, and curved designs of their reflective cups are also different. The manufacturing material of the LED light source 310 of the front lamp head 300 is different from that of the LED light source 310 of the rear lamp head 400, so that the color temperature of the front lamp head 300 is different from that of the rear lamp head 400. The curve design of the reflective cup 320 for the front lamp head 300 is different from that for the rear lamp head 400, so that the illumination distance of the front lamp head 300 is different from that of the rear lamp head 400, so that the illumination area of the front lamp head 300 is different from that of the rear lamp head 400.

As shown in FIGS. 1 and 2, the astigmatic lens 600 is disposed on the outside of the shell 230. During lighting, the astigmatic lens 600 is disposed on the light-emitting side of the front lamp head 300 or the rear lamp head 400. The light emitted by the LED light source 310 passes through the lens 330 and the astigmatic lens 600 successively. The astigmatic lens 600 is configured with a rotating bracket 610, and the rotating bracket 610 is sleeved on the external surface of the lamp body 200. The rotating bracket 610 is vertically disposed with the astigmatic lens 600, and on the lamp body 200, the rotating bracket 610 can rotate 360 degrees around the axis of the lamp body 200, and the relative position between the astigmatic lens 600 and the shell 230 can be adjusted by rotating the rotating bracket 610.

### Embodiment 2

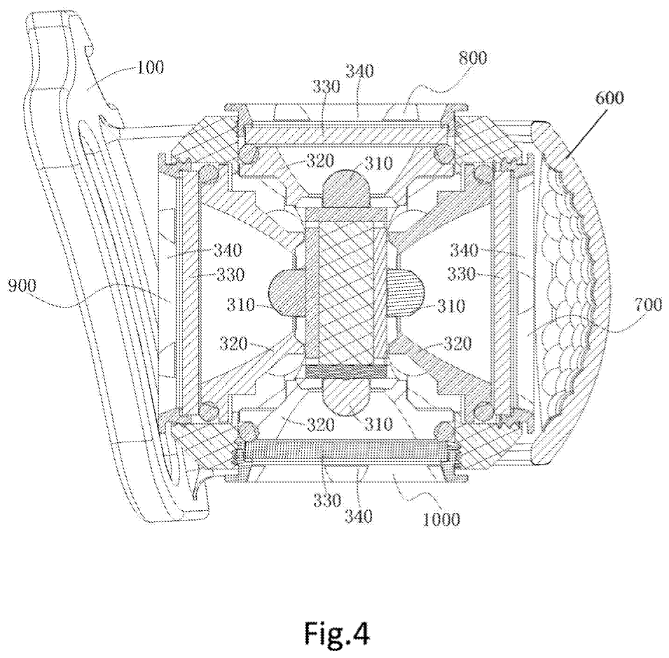

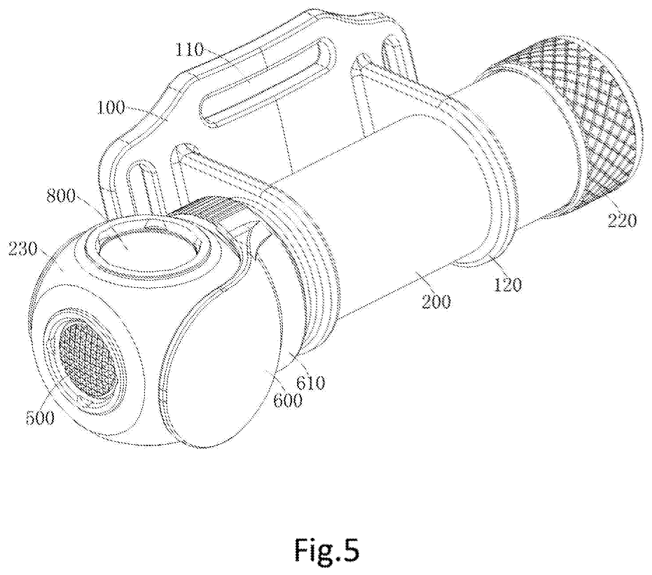

As shown in FIGS. 4 and 5, the differences between the cross-country running lamp in this embodiment and the cross-country running lamp in Embodiment 1 are: the peripheral side of the lamp body 200 is equipped with four lamp heads, and the four lamp heads are the first lamp head 700, the second lamp head 800, the third lamp head 900 and the fourth lamp head 1000. The first lamp head 700, the second lamp head 800, the third lamp head 900 and the fourth lamp head 1000 are disposed on the peripheral side of the shell 230 at equal intervals around the axis of the lamp body 200, and are installed in the four cavities 231 respectively. Thus, the external surfaces of the adjacent lamp heads are perpendicular to each other. Switch 500 is disposed on the lamp body 200, in the middle of the end face of the shell 230 away from the lamp body 200. The switch 500 is used to control the four lamp heads on and off and brightness. In actual operation, working modes of the lamp heads are selected by the times of pressing the switch. For example, when pressing the switch 500 for the first time, the first lamp head 700 is turned on and emits strong light; when pressing the switch 500 for the second time, the first lamp head 700 emits weak light; when pressing switch 500 for the third time, the first lamp head 700 is turned off; when pressing switch 500 for the fourth time, the second lamp head 800 is turned on and emits strong light; when pressing switch 500 for the fifth time, the second lamp head 800 emits weak light; when pressing switch 500 for the sixth time, the second lamp head 800 is turned off, and so on.

The structures and installations of the first lamp head 700, the second lamp head 800, the third lamp head 900 and the fourth lamp head 1000 are basically the same as the structures and installations of the front lamp head 300 and the rear lamp head 400 in Embodiment 1, thus will not be further discussed herein.

### Embodiment 3

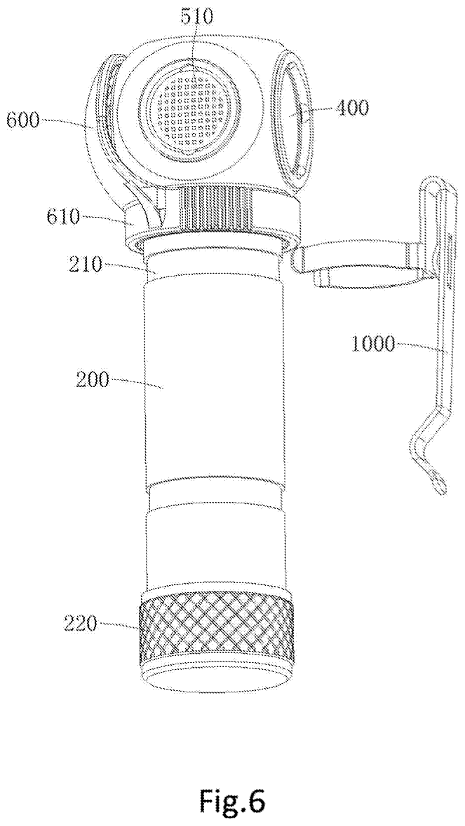

As shown in FIG. 6, the difference between the cross-country running lamp in this embodiment and the cross-country running lamp in Embodiment 1 is: The cross-country running lamp adopts a holding clip 1100 instead of a mounting bracket 100. The holding clip 1100 is a holding clip in the conventional art. The holding clip 1100 is a stainless steel plated titanium holding clip that can be installed in both directions, and the holding clip 1100 is clamped in the groove 210 of the lamp body 200.

### Embodiment 4

The difference between the cross-country running lamp in this embodiment and the cross-country running lamp in the Embodiment 2 is: the cross-country running lamp adopts the holding clip 1100 instead of the mounting bracket 100. The holding clip 1100 is the holding clip in the conventional art. The holding clip 1100 is a stainless steel plated titanium holding clip that can be installed in both directions. The holding clip 1100 is clamped on the groove 210 of the lamp body 200. The specific structure of the holding clip 1100 can be referred to Embodiment 3.

Compared with the known art, the cross-country running lamp of embodiments of in this disclosure is equipped with at least two lamp heads, and the light source of each lamp head adopts a different color temperature, and the reflective cup 320 adopts a different curve design, so that the cross-country running lamp has a variety of illumination effects. In addition, the brightness of this cross-country running light can be adjusted by the times of the switch pressed, therefore achieve more illumination effects. For example, the cross-country running lamp in the Embodiment 1 can achieve the illumination effects of white condensing light, white astigmatism light, yellow condensing light, and yellow astigmatism light. With the use of the astigmatic lens 600, the cross-country running light presents the effect of astigmatism, thus generating more illumination effects.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

What is claimed:

1. A cross-country running lamp, comprising:
a lamp body;
at least two lamp heads disposed on a peripheral side of the lamp body for illumination; and
at least one switch disposed on the lamp body for controlling on-off and brightness of the lamp heads.

2. The cross-country running lamp according to claim 1, further comprising: a shell disposed on one end of the lamp body, the lamp heads are mounted on a peripheral side of the shell, and the switch is mounted on the shell.

3. The cross-country running lamp according to claim 2, wherein the lamp heads comprise a front lamp head and a rear lamp head, and the cross-country running lamp comprises a front switch and a rear switch; the front lamp head, the front switch, the rear lamp head and the rear switch are disposed successively around a center line of the lamp body on the peripheral side of the shell; and
a mounting face of the front lamp head is perpendicular to a mounting face of the front switch, the mounting face of the front lamp head is perpendicular to a mounting face of the rear switch, and the mounting face of the front lamp head is parallel to a mounting face of the rear lamp head.

4. The cross-country running lamp according to claim 2, wherein the lamp heads comprise a first lamp head, a second lamp head, a third lamp head and a fourth lamp head, the first lamp head, the second lamp head, the third lamp head and the fourth lamp head are disposed successively around a center line of the lamp body on the peripheral side of the shell; the switch is disposed on an end face of the shell away from the lamp body, and the switch controls on-off and brightness of the first lamp head, the second lamp head, the third lamp head and the fourth lamp head; mounting surfaces of the adjacent lamp heads are perpendicular to each other.

5. The cross-country running lamp according to claim 1, wherein each lamp head comprises an LED light source, a reflective cup, a lens and a pressure ring, and manufacturing materials of the LED light source of the lamp heads are different from each other.

6. The cross-country running lamp according to claim 5, wherein the reflective cup of each lamp head has a different internal curved shape.

7. The cross-country running lamp according to claim 1, further comprising: an astigmatic lens disposed on a luminous side of the lamp body.

8. The cross-country running lamp according to claim 2, further comprising: an astigmatic lens disposed on an illuminating side of the lamp body.

9. The cross-country running lamp according to claim 7, wherein the astigmatic lens is configured with a rotating bracket, the rotating bracket is disposed on an external surface of the lamp body and rotatable around a center line of the lamp body.

10. The cross-country running lamp according to claim 8, wherein the astigmatic lens is configured with a rotating bracket, the rotating bracket is disposed on an external surface of the lamp body and rotatable around a center line of the lamp body.

11. The cross-country running lamp according to claim 1, further comprising: amounting bracket comprising at least one through hole for insertion of the lamp body, and comprising at least one mounting hole.

12. The cross-country running lamp according to claim 2, further comprising: amounting bracket comprising at least one through hole for insertion of the lamp body, and comprising at least one mounting hole.

13. The cross-country running lamp according to claim 11, wherein an external surface of the lamp body has a groove and the mounting bracket is engaged with the groove.

14. The cross-country running lamp according to claim 12, wherein an external surface of the lamp body has a groove and the mounting bracket is clamped in the groove.

15. The cross-country running lamp according to claim 1, further comprising: a holding clip, an external surface of the lamp body has a groove, and the holding clip is clamped in the groove.
